(19) United States
(12) Patent Application Publication
(10) Pub. No.: US 2026/0197404 A1
(43) Pub. Date: Jul. 9, 2026

(54) IMAGE FORMING SYSTEM AND INSPECTION APPARATUS

(71) Applicant: CANON KABUSHIKI KAISHA, Tokyo (JP)

(72) Inventor: TAKESHI SHINYA, Chiba (JP)

(21) Appl. No.: 19/428,573

(22) Filed: Dec. 22, 2025

(30) Foreign Application Priority Data
Jan. 6, 2025 (JP) 2025-001912

(51) Int. Cl. H04N 1/00

(52) U.S. Cl. CPC H04N 1/00005; H04N 1/0066; H04N 1/00769; H04N 1/00779

(57) ABSTRACT

An image forming system comprises an image forming apparatus and an inspection apparatus, and the image forming apparatus forms, on a recording medium, an image to which a predetermined image is attached to create a printed material, and provides the inspection apparatus with information regarding the predetermined image. The inspection apparatus obtains a read image by reading the printed material created by the image forming apparatus, inspects an image of the printed material by collating the read image and a reference image, and attaches the predetermined image to the reference image before the inspection on the image of the printed material based on the information.

### BACKGROUND

### FIELD OF THE TECHNOLOGY

The present disclosure relates to an image forming system and an inspection apparatus.

### DESCRIPTION OF THE RELATED ART

There are cases where a coloring material, such as ink or toner, adheres to an unintended section and forms a stain on a printed material that is printed and output by a printing apparatus. Also, there are cases where a sufficient amount of coloring material does not adhere to a section in which an image is to be formed by adhesion of the coloring material, thereby resulting in color omission (color missing) where the color of this section is lighter than the intended color. A so-called printing defect, like the aforementioned stain or color omission, causes a decrease in the quality of a printed material. For this reason, it is necessary to guarantee the quality of a printed material by inspecting whether there is such a printing defect on the printed material.

A visual inspection, in which an inspector visually inspects whether there is a printing defect on a printed material, requires large amounts of time and cost. Therefore, in recent years, an inspection system that performs inspection automatically, without relying on visual inspection, has been proposed. Specifically, a digital image (reference image) that has been used in printing and a scan image obtained by scanning a printed material are aligned, and collation and determination processing is executed with respect to these two images that have been aligned. In this way, it is determined whether there is a printing defect on a printed material, and the image quality of the printed material is determined.

Furthermore, an adjustment function that automatically performs adjustment of front and back image positions and tint of a printed material is also known. According to this, when printing is performed, patches for adjustment of tint, patches for adjustment of front and back image positions, and the like are attached outside (hereinafter, a margin region) the size of a finished deliverable, and then printing is performed. Note that such images as patches are attached at an interval set by a user, such as every 100 pages, for example. Then, at the time of the inspection, a task of adjusting front and back image positions and tint of a printed material is automatically performed by scanning an image of the printed material provided with the attached patches.

In recent years, there is demand for the ability to use a single printing system to execute a print job that carries out both an inspection function and an adjustment function. However, when inspection is performed on a printed material provided with attached images such as patches, the scan image of the printed material and the reference image do not match, and thus it is determined that there is a printing defect in the inspection. Therefore, in the case of a printed material provided with such attached images, an accurate inspection result cannot be obtained. This is because, although the printed material to be inspected includes the attached images, the pre-registered reference image that is compared with this printed material does not include the attached images.

It is described in Japanese Patent Laid-Open No. 2020-38483 that, when a print job that uses both an inspection function and an adjustment function is executed, a region in which attached images are printed is excluded from being an inspection target, and thus inspection can be performed accurately even in the case where the printed material to be inspected includes attached images.

However, according to the technique of Japanese Patent Laid-Open No. 2020-38483, a region in which attached images are printed is excluded from the inspection targets, and therefore the entire surface of a printed material cannot be inspected. Specifically, for example, in a case where there is an image defect such as a stain or color omission in a patch region, patches for tint adjustment are not read normally, and thus the adjustment function may not operate accurately.

### SUMMARY

Embodiments of the present disclosure eliminate the above-mentioned issues with conventional technology.

A feature of embodiments of the present disclosure is to provide a technique where, even when images for an adjustment function of an image forming apparatus have been attached to a printed material, it is possible to execute an inspection on this printed material and adjustment processing related to the attached images.

According to embodiments of the present disclosure, there is provided an image forming system comprising an image forming apparatus and an inspection apparatus, the image forming apparatus having one or more first controllers including one or more first processors and one or more first memories, wherein the one or more first controllers configured to: form, on a recording medium, an image to which a predetermined image is attached to create a printed material; and provide the inspection apparatus with information regarding the predetermined image, and the inspection apparatus having one or more second controllers including one or more second processors and one or more second memories, wherein the one or more second controllers configured to: obtain a read image by reading the printed material created by the image forming apparatus; inspect an image of the printed material by collating the read image and a reference image; and based on the information, attach the predetermined image to the reference image before the inspection on the image of the printed material.

Further features of the various embodiments will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the disclosure and, together with the description, serve to explain the principles of the disclosure.

FIG. 1 is a diagram showing an exemplary configuration of an image forming system that includes an inspection apparatus according to a first embodiment of the present disclosure.

FIG. 2 is a block diagram for describing a hardware configuration of an image forming apparatus according to the first embodiment.

FIG. 3 is a diagram for describing mechanisms of the image forming apparatus according to the first embodiment.

FIG. 4A is a diagram for describing an outline of an internal configuration of the inspection apparatus according to the first embodiment.

FIG. 4B depicts a top view of a conveyance belt as viewed from a side where an inspection sensor is located.

FIG. 5 is a block diagram for describing a configuration of an inspection apparatus control unit in the inspection apparatus according to the first embodiment.

FIG. 6A is a diagram for describing an outline of an internal configuration of an adjusting apparatus according to the first embodiment.

FIG. 6B is a block diagram for describing a hardware configuration of an adjusting apparatus control unit in the adjusting apparatus according to the first embodiment.

FIG. 7 is a flowchart for describing inspection processing by the inspection apparatus according to the first embodiment.

FIG. 8 is a diagram showing an example of a setting screen for an inspection level displayed on an operation and display unit of the inspection apparatus according to the first embodiment.

FIG. 9A is a diagram showing an example of a UI of inspection settings for adjustment, which is displayed on the operation and display unit of the inspection apparatus according to a second embodiment.

FIG. 9B is a diagram showing an example of a UI of inspection settings for adjustment, which is displayed on the operation and display unit of the inspection apparatus according to a modification example of the second embodiment.

FIGS. 10A and 10B are flowcharts for describing inspection processing by the inspection apparatus according to the modification example of the second embodiment.

FIGS. 11A and 11B are diagrams showing examples of a patch image according to the first embodiment.

FIGS. 11C and 11D are diagrams showing examples of a composite of a reference image and a patch image.

FIG. 12 is a flowchart for describing processing for attaching a patch image in step S705 of FIG. 7.

FIG. 13A is a diagram showing an example of a CMYK-to-RGB lookup table.

FIG. 13B is a diagram showing an example of a patch image list.

FIG. 13C is a diagram for describing an affine transformation.

FIG. 14 is a flowchart for describing result display processing of step S1017 according to the modification example of the second embodiment.

### DESCRIPTION OF THE EMBODIMENTS

Example embodiments of the present disclosure will be described hereinafter in detail, with reference to the accompanying drawings. It is to be understood that the following embodiments are not intended to limit the claims of the present disclosure, and that not all of the combinations of the aspects that are described according to the following embodiments are necessarily required with respect to the means to solve the issues according to the present disclosure. Further, in the accompanying drawings, the same or similar configurations are assigned the same reference numerals, and redundant descriptions are omitted. <First Embodiment>

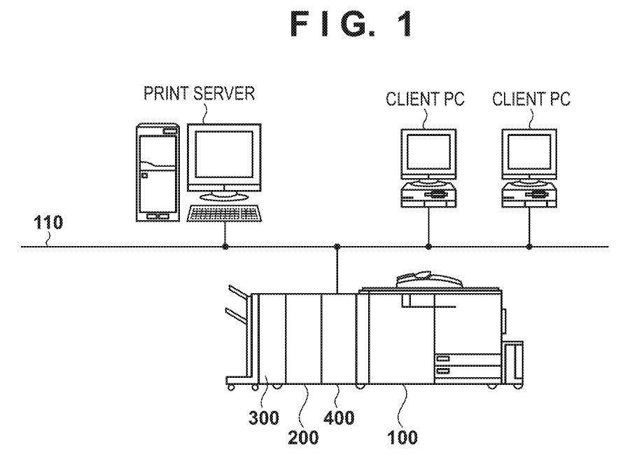

FIG. 1 is a diagram showing an exemplary configuration of an image forming system that includes an inspection apparatus 200 according to a first embodiment of the present disclosure.

An image forming apparatus 100 processes various types of input data, and prints an image on a recording medium, such as a sheet. An adjusting apparatus 400 receives a printed material output from the image forming apparatus 100, and adjusts the image forming apparatus 100. The inspection apparatus 200 receives the printed material output from the image forming apparatus 100, and inspects whether an image defect has occurred on this printed material. A finisher 300 receives the printed material inspected by the inspection apparatus 200, and performs bookbinding, stapling, punching (making holes), and so forth with respect to this printed material. The image forming apparatus 100 is connected to an external print server and client PCs via a network 110. The image forming apparatus 100 is connected to each of the inspection apparatus 200, finisher 300, and adjusting apparatus 400 via communication cables. Furthermore, the inspection apparatus 200, finisher 300, and adjusting apparatus 400 are also connected to one another via communication cables different from those mentioned above. The first embodiment will be described using an example of an in-line image forming system (inspection system) that performs image formation, image inspection, image adjustment, and finishing consistently.

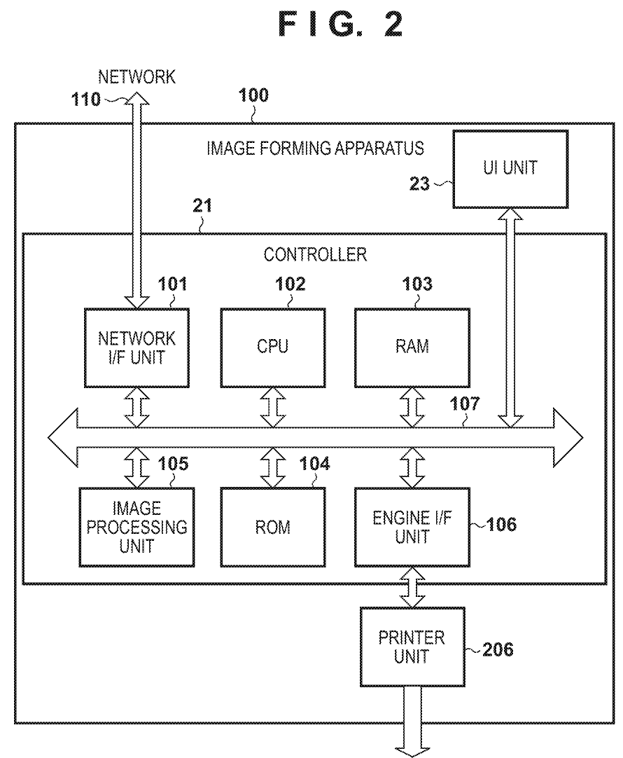

FIG. 2 is a block diagram for describing a hardware configuration of the image forming apparatus 100 according to the first embodiment.

The image forming apparatus 100 includes a controller 21, a printer unit 206, and a user interface (UI) unit (operation unit) 23. Note that the UI unit 23 includes various types of switches, display units, and the like for operations.

Image data or document data created by the client PCs in the network, or an application in the print server, such as a non-illustrated printer driver, is transmitted as PDL data to the image forming apparatus 100 via the network 110 (e.g., a LAN). In the image forming apparatus 100, a controller 21 receives the transmitted PDL data. The controller 21 is connected to the printer unit 206, and upon receiving PDL data from a client PC or the print server, converts this PDL data into print data that can be processed in the printer unit 206. Then, the print data is output to and printed by the printer unit 206.

The printer unit 206 prints an image based on the print data output from the controller 21. Note that the printer unit 206 according to the first embodiment is assumed to be a printer engine of an electrophotographic method. Note that a printing method is not limited to this, and may be an inkjet (IJ) method, for example.

The UI unit 23 is operated by a user, and is used by the user to select various types of functions and to issue operational instructions. This UI unit 23 includes, for example, a display unit with a touch panel provided on a surface thereof, and a keyboard with various types of keys, such as a start key, a stop key, numeric keys, and the like, arranged therein.

Next, the details of the controller 21 will be described.

The controller 21 includes a network I/F (interface) unit 101, a CPU 102, a RAM 103, a ROM 104, an image processing unit 105, an engine I/F unit 106, and an internal bus 107. The network I/F unit 101 is an interface for receiving PDL data transmitted from a client PC or a print server. The CPU 102 controls the entirety of the image forming apparatus 100, and also executes later-described processing carried out by the controller 21, with use of programs and data stored in the RAM 103 and the ROM 104. The RAM 103 provides a working area that is used when the CPU 102 executes various types of processing. The ROM 104 stores programs and data for causing the CPU 102 to execute various types of processing, which will be described later, setting data of the controller 21, and the like.

The image processing unit 105 executes image processing for printing with respect to the PDL data received by the network I/F unit 101 in accordance with settings from the CPU 102, thereby generating print data that can be processed by the printer unit 206. The image processing unit 105 generates image data that includes a plurality of color components on a per-pixel basis (RIP data), particularly by rasterizing the received PDL data. The plurality of color components denote color components that are independent in a color space, such as R, G, and B (red, green, and blue). In image data, each pixel has, for example, an 8-bit (256-tone) value per color component. That is to say, image data is multi-valued bitmap data that includes multi-valued pixel data. Furthermore, in the aforementioned rasterization, attribute data that indicates an attribute of a pixel of image data on a per-pixel basis is also generated in addition to the image data. This attribute data indicates to what type of objects the pixels belong, and is values indicating object types, such as characters, a line, a graphic, an image, and a background. Using the generated image data and attribute data, the image processing unit 105 applies image processing, such as color conversion from an RGB color space into a CMYK (cyan, magenta, yellow, and black) color space and screen processing, thereby generating print data.

The engine I/F unit 106 is an interface that transmits the print data generated by the image processing unit 105 to the printer unit 206. The internal bus 107 is a system bus that connects among the above-described units and transmits control signals and the like.

Note that the functions of the image processing unit 105 may not be realized by hardware, and may be realized by, for example, the CPU 102 executing a program deployed to the RAM 103.

FIG. 3 is a diagram for describing mechanisms of the image forming apparatus 100 according to the first embodiment.

The image forming apparatus 100 includes a scanner unit 301, a laser exposure unit 302, photosensitive drums 303, an image forming unit 304, a fixing unit 305, a feeding and conveyance unit 306, and a printer control unit 308 that controls them. The scanner unit 301 optically reads an original image while irradiating an original placed on a platen with illumination light, and creates image data by converting this image into electrical signals. The laser exposure unit 302 causes light rays, such as laser light, that have been modulated in accordance with the image data to be incident on a rotational multifaceted mirror (polygon mirror) 307 that rotates at a constant angular velocity, and uses the light rays as reflected scan light to irradiate the photosensitive drums 303. The image forming unit 304 rotates and drives the photosensitive drums 303, charges them with use of respective chargers, and develops latent images that have been formed on the respective photosensitive drums by the laser exposure unit 302 with use of respective color toners. Furthermore, four consecutive developing units (developing stations) are provided that execute a series of electrophotographic processes in which the toner images are transferred to a sheet (paper), and minute toners that remain on the photosensitive drums without being transferred at that time is collected; in this way, image formation is realized. Regarding the four consecutive developing units that are arranged in order of cyan (C), magenta (M), yellow (Y), and black (K), after a predetermined period has elapsed since the start of image formation in the cyan station, the operations of forming magenta, yellow, and black images are executed in succession.

The fixing unit 305 includes rollers, belts, and the like, and further includes a heat source, such as a halogen heater, built therein; the fixing unit 305 causes toner on a sheet to which the toner images have been transferred by the image forming unit 304 to be dissolved and fixed by heat and pressure. Note that when printing is performed on thick paper, as the paper is thick and the thermal conductivity is poor, the conveyance speed of paper to pass through the fixing unit 305 needs to be set at a speed that is half a normal speed, for example. Due to this, when printing is performed on thick paper, the conveyance speed of the paper in each unit other than the fixing unit 305 is reduced by half, too, and thus the printing speed of the image forming apparatus 100 per se is reduced by half.

The feeding and conveyance unit 306 has one or more paper stowing compartments, which are typically paper cassettes and paper decks; in accordance with an instruction from the printer control unit 308, the feeding and conveyance unit 306 separates one sheet of paper from a plurality of sheets of paper stowed in the paper stowing compartment, and conveys the sheet of paper to the image forming unit 304. The aforementioned developing stations transfer toner images of the respective colors to the sheet that has been thus conveyed in such a manner that the toner images overlap one another, and a full-color toner image is eventually formed on the sheet. Also, in a case where an image is formed on both sides of the sheet, control is performed so that the sheet that has passed through the fixing unit 305 once again passes through a conveyance path via which the sheet is conveyed to the image forming unit 304.

The printer control unit 308 communicates with the controller 21 that controls the entirety of the image forming apparatus 100, and executes control in accordance with an instruction therefrom. Also, the printer control unit 308 issues instructions so that the whole can operate smoothly in a coordinated manner while managing the state of each of the aforementioned scanner, laser exposure, image forming, fixing, and feeding and conveyance units.

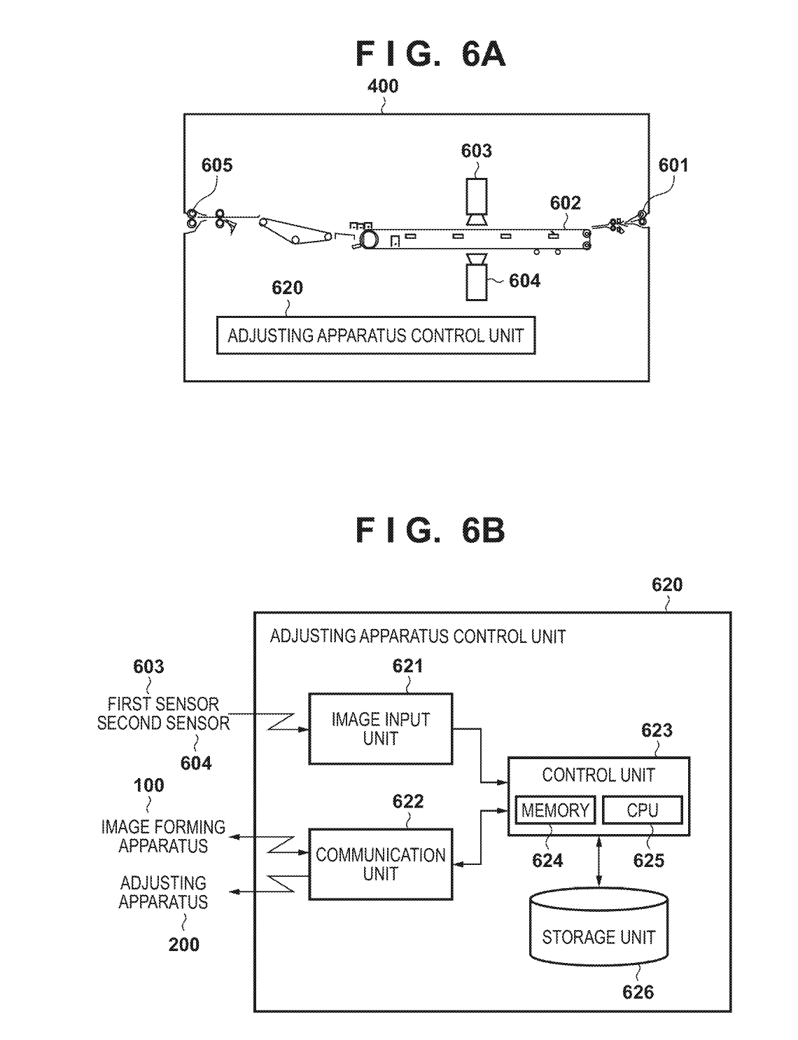

FIG. 6A is a diagram for describing an outline of an internal configuration of the adjusting apparatus 400 according to the first embodiment.

A sheet (printed material) output from the image forming apparatus 100 is drawn into the adjusting apparatus 400 by a feeding roller 601. Thereafter, while being conveyed by a conveyance belt 602, the printed material is read by a first sensor 603 and a second sensor 604 that are arranged above and below the conveyance belt 602 so as to oppose each other. The first sensor 603 reads patches for adjustment printed on an upper side of the printed material, and the second sensor 604 reads patches for adjustment printed on a lower side of the printed material. The adjusting apparatus 400 reads both sides of the printed material with use of the first sensor 603 and the second sensor 604 at a timing at which the printed material conveyed on the conveyance belt 602 arrives at a predetermined position. Then, based on the result of this reading, an adjusting apparatus control unit 620 performs adjusting processing. The sheet that has been conveyed inside the adjusting apparatus 400 and discharged by a discharge roller 605 in this manner is conveyed to the inspection apparatus 200.

FIG. 6B is a block diagram for describing a hardware configuration of the adjusting apparatus control unit 620 in the adjusting apparatus 400 according to the first embodiment.

Control on the adjusting apparatus control unit 620 is entirely performed by a control unit 623. The control unit 623 includes a CPU 625, and this CPU 625 executes patch reading processing by deploying a program stored in a storage unit 626 to a memory 624 in the control unit 623 and executing the deployed program. An image input unit 621 obtains a patch image based on signals from the first sensor 603 and the second sensor 604. Then, the control unit 623 obtains patch information based on this patch image. Then, the control unit 623 adjusts printed colors and front and back misregistration by notifying the image forming apparatus 100 of the patch information and rewriting setting values and the like on the image forming apparatus 100 via a communication unit 622. Also, the communication unit 622 may perform control so as not to notify the image forming apparatus 100 of the patch information by communicating with the inspection apparatus 200, too. The details of this will be described later.

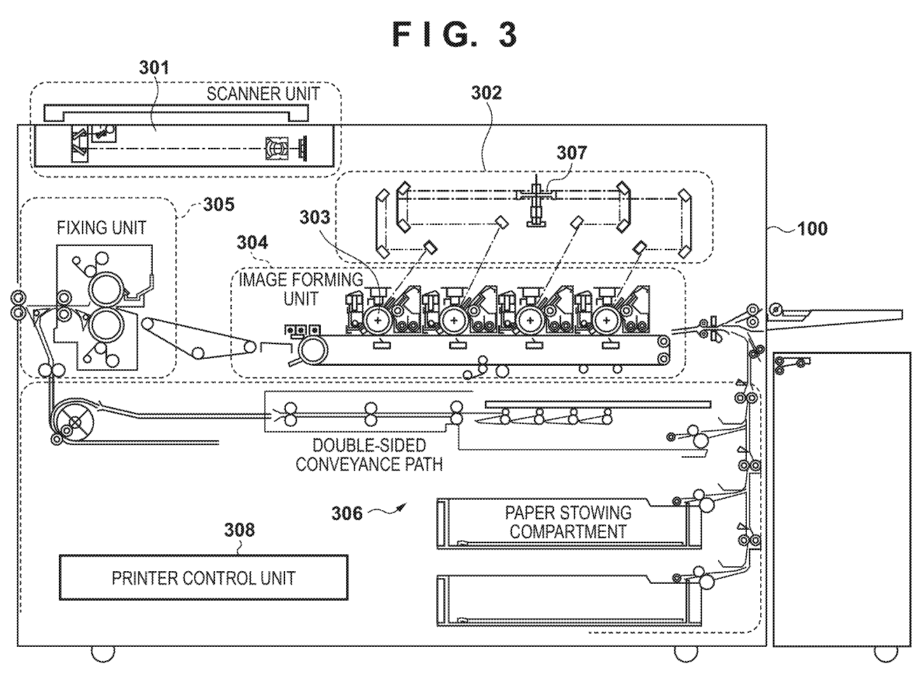

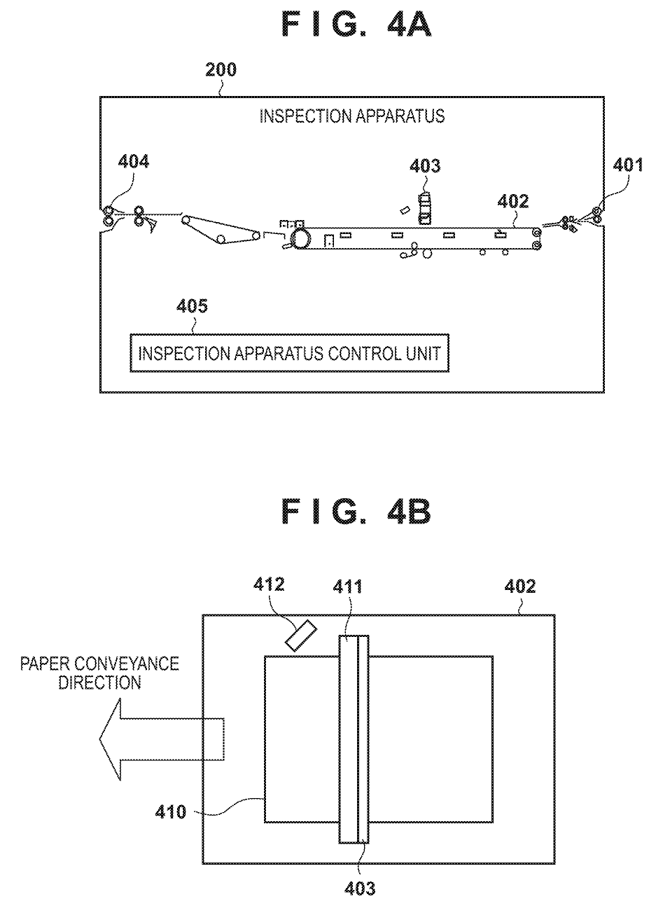

FIG. 4A is a diagram for describing an outline of an internal configuration of the inspection apparatus 200 according to the first embodiment.

A sheet (printed material) output from the image forming apparatus 100 is drawn into the inspection apparatus 200 by a feeding roller 401 after passing through the adjusting apparatus 400. Thereafter, while being conveyed by a conveyance belt 402, the printed material is read by an inspection sensor 403 located above the conveyance belt 402. An inspection apparatus control unit 405 executes inspection processing with use of image data (scan image) obtained by this inspection sensor 403 reading the printed material. Furthermore, the inspection apparatus control unit 405 also controls the entirety of the inspection apparatus 200. The results of this inspection are transmitted to the finisher 300. The printed material after the inspection has been performed is discharged by a discharge roller 404. Although not illustrated here, it is possible to adopt a structure in which both sides of a printed material are read by arranging the inspection sensor 403 below the conveyance belt 402, too, so that a printed material on which double-sided printing has been performed can also be handled.

FIG. 4B depicts a top view of the conveyance belt 402 as viewed from a side where the inspection sensor 403 is located.

Here, the inspection sensor 403 is a line sensor that reads an image of an entire surface of a printed material 410 that has been conveyed as shown in the figure on a per-line basis. An irradiation device 411 irradiates the printed material 410 with white light when it is read by the inspection sensor 403. An irradiation device 412 for skew feeding detection is a device for detecting whether the printed material 410 is undergoing skew feeding relative to a conveyance direction when conveyed on the conveyance belt 402. The irradiation device 412 for skew feeding detection creates a shadow of an edge portion of the printed material 410 by irradiating the conveyed printed material 410 in an oblique direction with light, and skew feeding of the printed material 410 is detected by the inspection sensor 403 reading this shadow image. Although the first embodiment adopts a configuration in which reading of the shadow image of the edge portion of the printed material 410 is performed by the inspection sensor 403, it may adopt a configuration in which another reading sensor other than the inspection sensor 403 is used.

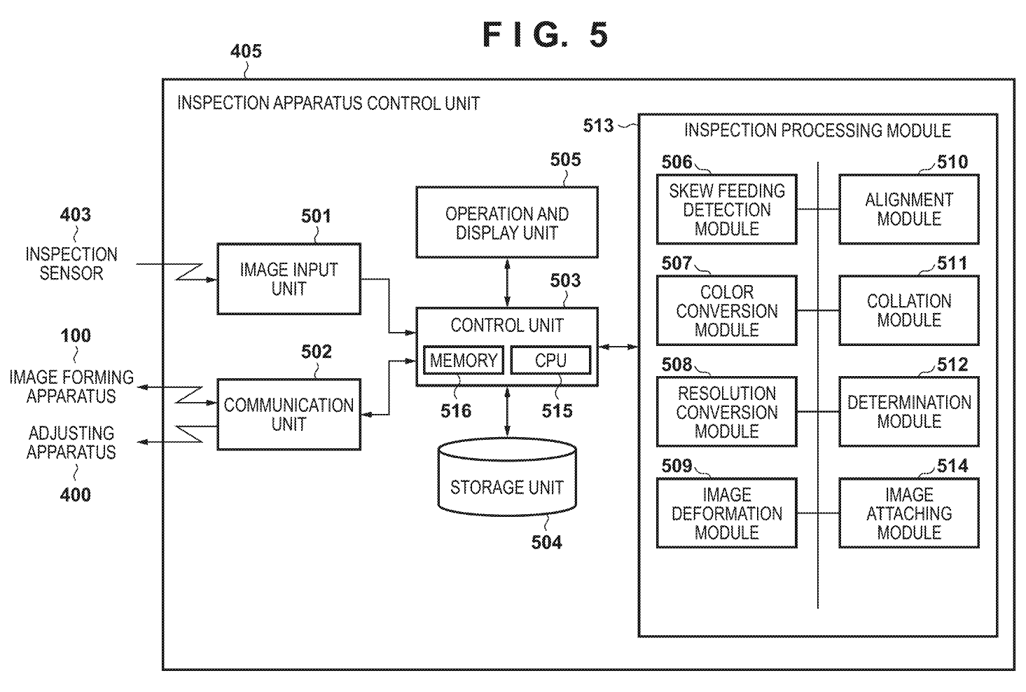

FIG. 5 is a block diagram for describing a configuration of the inspection apparatus control unit 405 in the inspection apparatus 200 according to the first embodiment.

Control on the inspection apparatus control unit 405 is entirely performed by a control unit 503. The control unit 503 includes a CPU 515, and this CPU 515 executes various types of processing, which will be described later, by deploying a program stored in a storage unit 504 to a memory 516 in the control unit 503 and executing the deployed program. An image input unit 501 receives, as an input, a scan image (read image) that has been obtained by reading a printed material with use of the inspection sensor 403. The CPU 515 saves this scan image in the storage unit 504. Also, a communication unit 502 communicates with the controller 21 in the image forming apparatus 100. This communication is reception of image data (a reference image) that was used in printing in correspondence with the scan image, transmission/reception of inspection control information pieces, and the like. The CPU 515 also saves the received reference image and inspection control information pieces in the storage unit 504.

One piece of inspection control information exchanged with the image forming apparatus 100 is synchronization information for establishing correspondence between the scan image (inspection image) and the reference image, such as print job information, printing copy number information, and page order information. Others are inspection result information, and control information for controlling the operations of the image forming apparatus 100 accordingly. On the assumption that the orders of the scan image received by the inspection apparatus 200 and the reference image used to print the scan image varies for double-sided printing and printing of a plurality of copies, the synchronization information is necessary for establishing synchronization between the reference image and the scan image. Also, as there are cases where one reference image corresponds to a plurality of scan images, the synchronization information is necessary to establish synchronization between the reference image and the scan image. Inspection control information exchanged between the inspection apparatus 200 and the finisher 300 includes inspection result information, and control information for controlling the operations of the finisher 300 accordingly.

In addition, the communication unit 502 also communicates with the communication unit 622 in the adjusting apparatus 400. This communication is intended for notification of a later-described inspection result.

The CPU 515 of the control unit 503 controls the operations of an inspection processing module 513. The inspection processing module 513 obtains corresponding pairs of a scan image and a reference image based on synchronization information, which is one piece of the aforementioned inspection control information exchanged with the image forming apparatus 100, and inspection processing is executed with respect to scan images in succession. The details of the inspection processing module 513 will be described later. Once the inspection processing has ended, the results of determination thereof are transmitted to the control unit 503, and displayed on an operation and display unit 505. In a case where an image defect has been found as a result of this determination, control on the image forming apparatus 100 and the finisher 300 is switched via the communication unit 502 in accordance with a method that has been designated in advance by a user via the operation and display unit 505. For example, processing for stopping image forming processing by the image forming apparatus 100, switching a discharge tray of the finisher 300 to an escape tray, and the like is executed.

Next, a configuration of the inspection processing module 513 will be described.

A skew feeding detection module 506 is a module that detects a skew feeding angle of a printed material. As described above with reference to FIG. 4B, a scan image has been scanned in such a manner that a shadow is formed on an edge portion of the printed material. The purpose of this is to scan the shadow of the edge portion of the printed material, which is formed when the irradiation device 412 for skew feeding detection irradiates the printed material with light, with use of the inspection sensor 403 when the printed material has been drawn into the inspection apparatus 200 and conveyed on the conveyance belt 402. Using this shadow, a skew angle of the printed material, that is to say, a skew feeding angle of the scan image, is detected. A later-described image deformation module 509 executes processing for correcting the scan image based on the skew feeding angle detected in this manner.

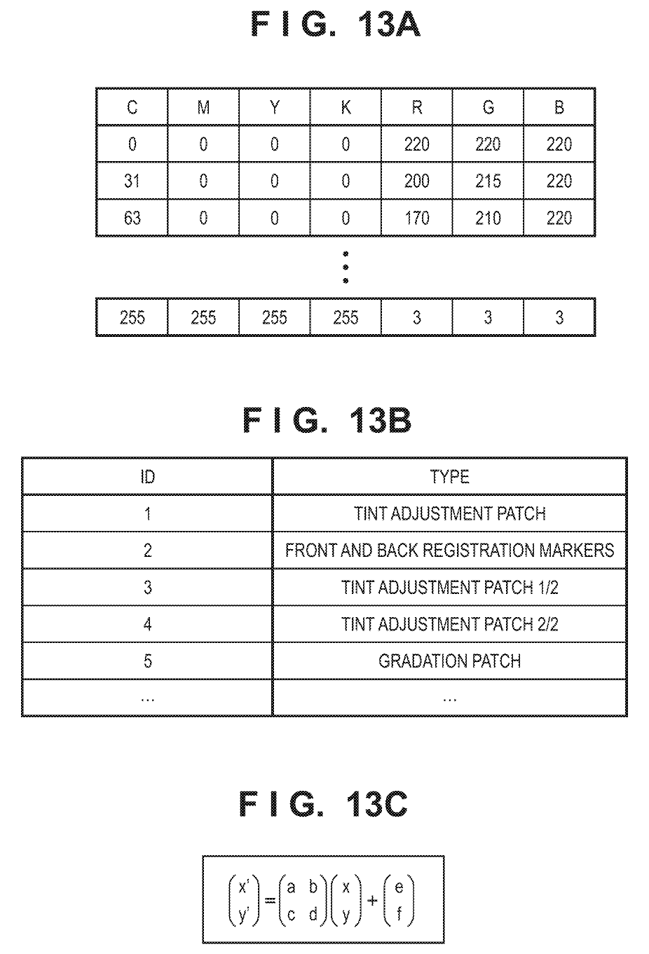

A color conversion module 507 is a module that performs color conversion for bringing the color space of the reference image into conformity with the color space of the scan image. The reference image has been rasterized in the CMYK color space by the image processing unit 105, and the scan image has been rendered in the RGB color space read by the inspection sensor 403. The color conversion module 507 converts the reference image into an RGB image. In this conversion, for example, a CMYK-to-RGB lookup table (hereinafter, LUT) shown in FIG. 13A may be used. In this case, regarding pixels that are located on grid points, color conversion into RGB is performed with reference to the conversion table; meanwhile, regarding pixels that are not located on grid points, RGB values are decided through interpolation based on neighboring grid points.

A resolution conversion module 508 is a conversion module for bringing the resolutions of the scan image and the reference image into conformity with each other. There is a case where the scan image and the reference image are different in resolution at the time when they are input to the inspection apparatus control unit 405. Also, there is a case where the resolution of the images used in each module of the inspection processing module 513 is different from the resolution of the input images. In such cases, this resolution conversion module 508 performs resolution conversion. For example, assume that the scan image has resolutions of 600 dpi and 300 dpi in the main-scanning and sub-scanning directions, respectively, and the reference image has a resolution of 1200 dpi in the main-scanning and sub-scanning directions. Here, in a case where the resolution required in the inspection processing module 513 is 300 dpi in both of the main-scanning and sub-scanning directions, each image is scaled down, thereby giving both images a resolution of 300 dpi in both of the main-scanning and sub-scanning directions. Here, it is sufficient to use a known method as a scaling method in view of a calculation load and a required precision. For example, if scaling that uses the SINC function is performed, the calculation load is heavy, but a highly precise scaling result can be attained. Also, if scaling that uses the nearest-neighbor algorithm is performed, the calculation load is light, but a low-precision scaling result is attained.

The image deformation module 509 is a module that performs image deformation with respect to the scan image and the reference image. There are geometric differences between the scan image and the reference image due to expansion/contraction and skew feeding of paper at the time of printing, and skew feeding at the time of scanning. The image deformation module 509 corrects such geometric differences by performing image deformation based on information obtained by the skew feeding detection module 506 and a later-described alignment module 510. For example, the geometric differences are linear transformation (rotation, magnification/reduction, and shearing) and translation. Such geometric differences can be represented as an affine transformation, and can be corrected by obtaining affine transformation parameters from the skew feeding detection module 506 and the alignment module 510. Note that information obtained from the skew feeding detection module 506 is only a parameter related to rotation (skew feeding angle information).

The alignment module 510 is a module that achieves alignment between the scan image and the reference image. The premise is that the scan image and the reference image input to this module are images of the same resolution. Note that the higher the input resolution, the higher the precision of alignment, and the larger the calculation load. The scan image and the reference image to be collated in a later-described collation module 511 can be obtained by performing correction in the image deformation module 509 based on parameters obtained through the alignment. While various alignment methods are conceivable as an alignment method, the first embodiment uses a method in which the entire surfaces of the images are aligned with use of information of partial regions of the images, rather than the entire surfaces of the images, to reduce the calculation load. The alignment according to the first embodiment is composed of three steps: selection of patches for alignment, alignment on a per-patch basis, and estimation of affine transformation parameters. A description is now given of each step.

First, selection of patches for alignment will be described. Here, "patches" refer to quadrilateral regions inside images. In selection of patches for alignment, a plurality of patches that are appropriate for alignment are selected from the reference image. Patches that are appropriate for alignment are patches that include large corner feature amounts therein. A corner feature is a feature where two marked edges of different directions exist in the vicinity of a certain local section (an intersection between two edges). A corner feature amount is a feature amount indicating the intensity of such edge features. Various methods have been designed based on differences in modeling of the "edge features". One of methods of calculating a corner feature amount is, for example, a known method called the Harris corner detector. The Harris corner detector calculates a corner feature amount image from a derivative image in the horizontal direction (an edge feature amount image in the horizontal direction) and a derivative image in the vertical direction (an edge feature amount image in the vertical direction).

This corner feature amount image is an image representing an edge amount of a weaker one of two edges composing a corner feature. As a corner feature is supposed to represent two edges that are both strong, the magnitude of the corner feature amount is indicated by whether there is a strong edge amount even in the case of a relatively weaker edge. Corner feature amount images are calculated from the reference image, and portions with large corner feature amounts are selected as patches that are appropriate for alignment. If regions with large corner feature amounts are simply selected in order as patches, patches may be selected only from limited regions. In this case, the regions around which no patch exists increase in number, and image deformation information of such regions cannot be used; therefore, this is not a state that is appropriate for alignment of the entire images. In view of this, when selecting patches, the dispersed arrangement of patches inside the image is also taken into account, rather than mere magnitudes of the corner feature amounts.

Specifically, even if the corner feature amount value of a certain patch candidate region is not large inside the entire image, this region is selected as a patch if this value is large inside a local region of the image. This enables distributed arrangement of patches inside the reference image. Parameters that are used when selecting patches include the sizes of patches and the number (or density) of patches. If patches are increased in both size and number, the precision of alignment is improved, but the calculation load increases.

Next, alignment on a per-patch basis will be described. In the alignment on a per-patch basis, alignment is achieved between a patch for alignment inside the reference image, which has been selected in a preceding stage, and a corresponding patch inside the scan image.

Two types of information are obtained as a result of the alignment: the first type is the central coordinates (refpX_i, refpY_i) of the i^{th} patch for alignment inside the reference image (i = 1 to N, where N is the number of patches). The second type is the position of these central coordinates inside the scan image (scanpX_i, scanpY_i). An alignment method may be any method, as long as it is a shift estimation method that can obtain the relationships (refpX_i, refpY_i) and (scanpX_i, scanpY_i). For example, conceivable methods include a method that places a patch corresponding to a patch for alignment in a frequency space with use of the FFT, obtains a correlation therein, and estimates a shift amount, among others.

Finally, estimation of affine transformation parameters will be described. The affine transformation is a coordinate transformation method represented by a formula shown in FIG. 13C.

In the formula shown in FIG. 13C, there are six types of affine transformation parameters: a, b, c, d, e, and f. Here, (x, y) corresponds to (refpX_i, refpY_i), and (x', y') corresponds to (scanpX_i, scanpY_i). The affine transformation parameters are estimated using the correspondence relationships obtained from the N patches. For example, the affine transformation parameters can be obtained using the least-squares method. Images after alignment correction can be created by deforming the reference image or the scan image in the image deformation module 509 based on the obtained affine transformation parameters, and can be used as a set of the reference image and the scan image used by the collation module 511.

The collation module 511 is a module that collates the scan image and the reference image. The scan image and the reference image that are input to this collation module 511 are images of the same resolution. Furthermore, the premise is that the scan image has been corrected by the alignment module 510 so that the images can be compared. The collation module 511 executes collation processing with use of the reference image and the scan image. When a difference between the reference image and the inspection image has been detected in the collation processing by the collation module 511, a determination module 512 determines whether this difference is equivalent to an image defect by comparing this difference with a predetermined value (threshold).

An image attaching module 514 is a module that attaches, for example, a patch image used in the adjustment function to the reference image. In the first embodiment, patches for tint adjustment and marks for front and back registration adjustment are called attached images. Upon receiving adjustment information for executing the adjustment function via the controller 21 in the image forming apparatus 100, the image attaching module 514 attaches the attached images to the reference image based on this adjustment information. The details will be described later.

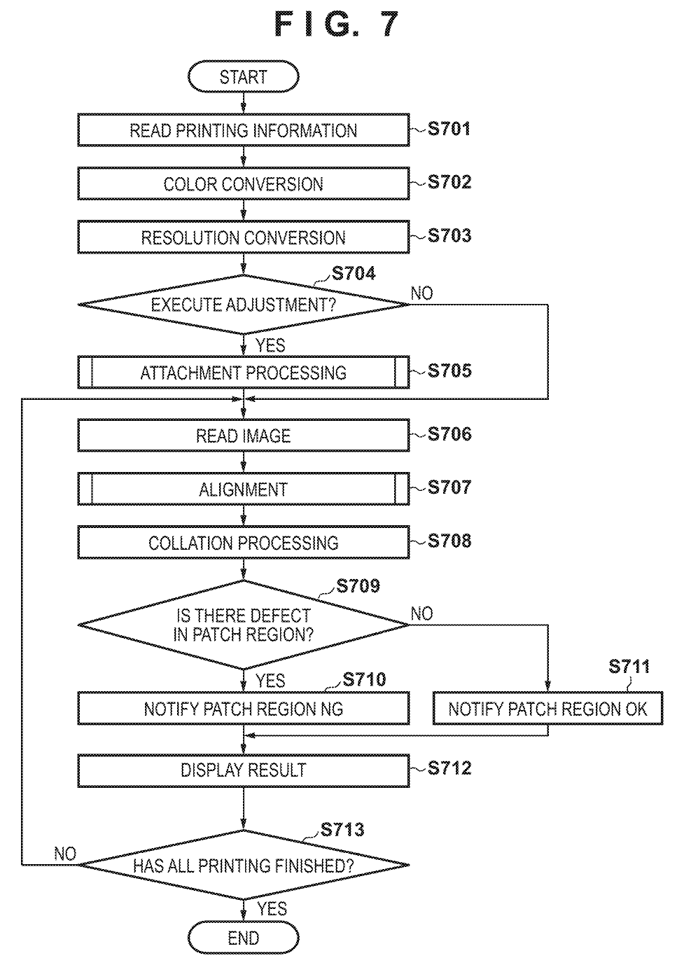

The following describes inspection processing with reference to FIG. 7.

FIG. 7 is a flowchart for describing the inspection processing by the inspection apparatus 200 according to the first embodiment. Note that processing described by this flowchart is realized by the CPU 515 of the control unit 503 executing a program deployed from the storage unit 504 to the memory 516.

First, in step S701, the CPU 515 receives printing information including RIP data, a paper size, and adjustment information from the image processing unit 105 via the controller 21 in the image forming apparatus 100. This adjustment information is information including whether to execute at least the adjustment function. In the first embodiment, it is assumed that this information includes rendering positions of patches, a patch type, and the like when the adjustment function is to be executed.

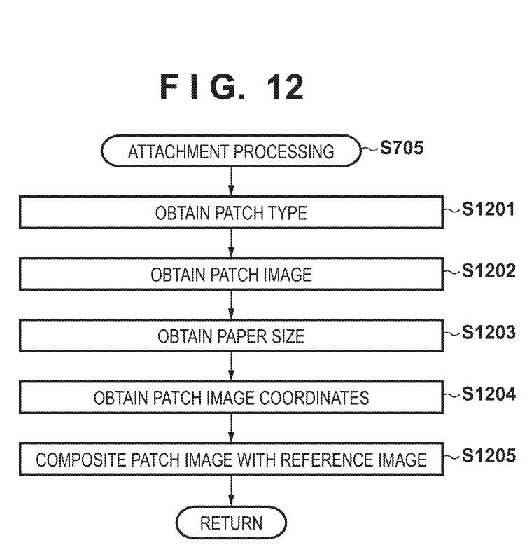

Next, processing proceeds to step S702, and the CPU 515 performs color conversion with respect to a reference image. Here, the color conversion module 507 performs the aforementioned CMYK-to-RGB color conversion to bring the reference image close to a scan image. Next, processing proceeds to step S703, and the CPU 515 performs resolution conversion with respect to the reference image. At this time, the CPU 515 causes the resolution conversion module 508 to convert the reference image into a predetermined resolution (e.g., 300 dpi × 300 dpi). Next, in step S704, the CPU 515 determines whether to execute the adjustment function in the image forming apparatus 100 based on the adjustment information received in step S701. When it has been determined that the adjustment function is to be executed, processing proceeds to step S705, and processing for attaching a patch image is executed. On the other hand, when it has been determined that the adjustment function is not to be executed, processing proceeds to step S706. Next, the CPU 515 executes processing for attaching such images as patches based on the adjustment information in step S705, and processing proceeds to step S706. The details of this attachment processing will be described later with reference to a flowchart of FIG. 12.

Next, in step S706, the CPU 515 obtains a scan image by reading a printed material output from the image forming apparatus 100 with use of the inspection sensor 403. Next, processing proceeds to step S707, and the CPU 515 performs alignment with use of the scan image obtained in step S706 and the reference image. Note, it is assumed here that the resolution of the scan image is the same as the resolution of the reference image, which is 300 dpi × 300 dpi, for example. Then, the CPU 515 obtains affine transformation parameters by causing the alignment module 510 to align the scan image and the reference image. Then, the CPU 515 causes the image deformation module 509 to execute correction processing with respect to the reference image with use of the affine transformation parameters obtained from the alignment module 510, thereby making the coordinate system of the reference image coincide with that of the scan image; consequently, the reference image is rendered usable in collation. Then, processing proceeds to step S708, and the CPU 515 causes the collation module 511 and the determination module 512 to execute collation and determination processing with use of the scan image obtained in step S706 and the reference image aligned in step S707.

Next, processing proceeds to step S709, and the CPU 515 determines whether there has been an image defect in a patch region. The patch region is indicated by coordinate information (position information) obtained by compositing a patch image with the reference image in the attachment processing of step S705, and this coordinate information is obtained from the storage unit 504. Here, in a case where it has been determined that there is an image defect in the patch region, processing proceeds to step S710. On the other hand, in a case where it has been determined that there is no image defect in the patch region, processing proceeds to step S711. In step S710, the CPU 515 notifies the adjusting apparatus 400 of the presence of the image defect inside the patch region via the communication unit 502, and processing proceeds to step S712. Upon receiving this notification, the adjusting apparatus 400 judges that the adjusting processing that is based on the patch image is meaningless, and provides the image forming apparatus 100 with a notification indicating that the adjustment result is not to be reflected. On the other hand, in step S711, in contrast with step S710, the CPU 515 notifies the adjusting apparatus 400 of the absence of the image defect inside the patch region via the communication unit 502, and processing proceeds to step S712. Upon receiving this notification, the adjusting apparatus 400 judges that the adjusting processing that is based on the patch image is meaningful, and provides the image forming apparatus 100 with the adjustment result.

Note that the notification destination in step S710 and step S711 is not limited to the adjusting apparatus 400. For example, the notification may be provided to the image forming apparatus 100, and the image forming apparatus 100 may provide notifications to both of the adjusting apparatus 400 and the inspection apparatus 200.

In step S712, the CPU 515 displays the result of the inspection processing on the operation and display unit 505. At this time, simply displaying an image indicating the final judgment result alone makes it difficult for a user to understand what kind of image defect is present. Therefore, the scan image is displayed on the operation and display unit 505 with an image of the final judgment result composited therewith. In this image composition, any composition method may be used as long as it is a composition method that makes it easy to understand the locations of the image defect. For example, portions with "1" in the image indicating the final judgment result, which represent sections of the image defect, are displayed in red on the scan image. Then, processing proceeds to step S713, and the CPU 515 judges whether the entire printing has finished; in a case where the entire printing has not finished, processing proceeds to step S706, and an image of a printed material output from the image forming apparatus 100 is read. On the other hand, in a case where it has been determined that the entire printing has finished in step S713, the present processing is ended.

Through the foregoing processing, an accurate inspection can be performed even in a case where a patch image is printed on a printed material to be inspected. Furthermore, when it has been determined that there is an image defect in a patch region that includes a patch image, the adjusting apparatus 400 is notified of the presence of the image defect; consequently, the adjustment function that is based on this patch image is not executed, which brings about the effect of prevention of erroneous adjustment caused by reading of an erroneous patch. <Details of Attachment Processing>

FIG. 12 is a flowchart for describing processing for attaching a patch image in step S705 of FIG. 7.

First, in step S1201, the CPU 515 obtains a patch type from the adjustment information. Next, processing proceeds to step S1202, and the CPU 515 obtains a patch image to be composited based on this obtained patch type. For example, a patch image list shown in FIG. 13B and patch images that correspond to patch IDs (patch identification information pieces) are held in the storage unit 504, and the patch type is read by referring to these. Note that this patch image list stores the types of patches and markers that can be attached by the image forming apparatus 100. Therefore, it is desirable that items printed by the image forming apparatus 100 be added thereto as appropriate.

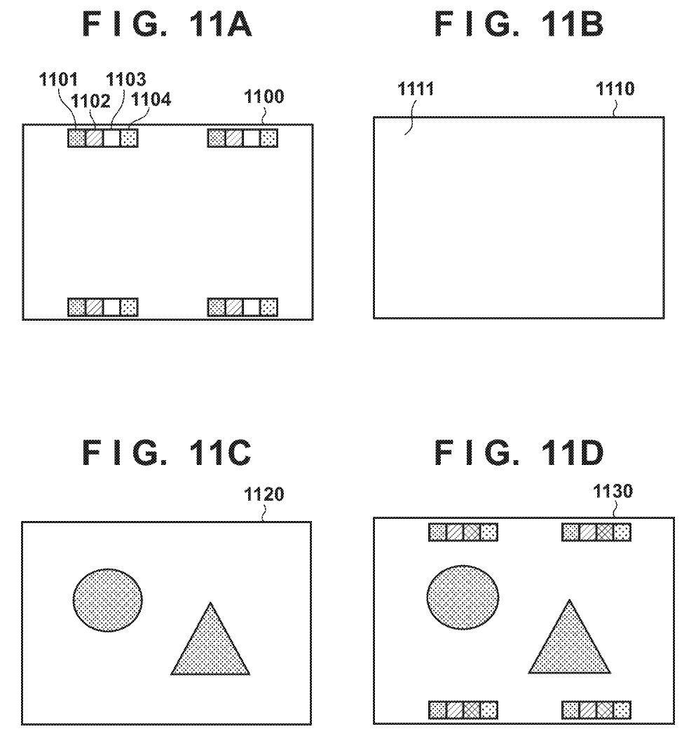

FIGS. 11A and 11B are diagrams showing examples of a patch image.

A patch image 1100 of FIG. 11A represents an example of a chart in which tint adjustment patches 1101 to 1104 are arranged, and a marker image 1110 of FIG. 11B represents an example of a chart in which front and back registration markers 1111, which are patches for adjusting front and back image positions, are arranged.

Here, it is desirable that the patch image be saved as an RGB image in the storage unit 504. In a case where it is saved as a CMYK image, the CMYK-to-RGB color conversion processing used in step S702 needs to be similarly executed.

Next, processing proceeds to step S1203, and the CPU 515 obtains a paper size from the printing information read in step S701. Then, the size of the patch image is changed in accordance with the obtained paper size. For example, assume that the patch image is held in an A3 size. Then, in a case where printing is to be performed in an A4 size, the patch image, too, is changed to the A4 size. It is sufficient for this change to be made in terms of the ratio of an image size; for example, in a case where a change from A3 to A4 is to be made, it is preferable to change the ratio from 3508 × 4960 to 2480 × 3508. Note that patch images may be held for respective paper sizes. Note that changing a patch image in accordance with a paper size can reduce the capacity of the storage unit 504. On the other hand, holding patches in correspondence with paper sizes increases a required capacity of the storage unit 504, but leads to a reduction in a calculation amount, that is to say, acceleration of processing.

Next, in step S1204, the CPU 515 obtains coordinate information of the patches from the adjustment information. Then, processing proceeds to step S1205, and the CPU 515 composites the patch image with the reference image in harmony with the obtained coordinate information of the patches. Here, a plurality of patch images may be selected, or the patch image 1100 and the marker image 1110 may be arranged together, for example. In this way, the patch image can be composited with the reference image in accordance with the adjustment information transmitted from the image forming apparatus 100.

FIG. 11C is a diagram showing an example of a reference image 1120 before composition. FIG. 11D is a diagram showing an example of an image 1130 obtained by compositing this reference image 1120 with the patch image 1100 including the tint adjustment patches of ID 1 and the marker image 1110 including the front and back registration markers with ID 2 in FIG. 13B. Then, the coordinate information of the attached patches are held in the storage unit 504.

Note that this attachment processing may be executed before step S702 and step S703. However, the processing speed is further accelerated by executing the attachment processing with respect to an image after the color conversion processing and the resolution conversion have been executed therefor. Therefore, the order shown in FIG. 12 is desirable.

Here, there may be cases where the adjustment information does not include the coordinate information of the patches. In such cases, the composition can be realized by distinguishing a patch image to be printed based on the RIP data and the paper size information received in step S701, and compositing the patches with the reference image at positions that have been decided in advance.

Note that a region in which the patch image has been composited is stored in the storage unit 504 as it is used when providing a notification indicating that the patch region is not good in the above-described step S710.

Note that in FIG. 12, the patch type is obtained from the adjustment information in step S1201, and a patch image to be composited is obtained based on this obtained patch type. However, the present disclosure is not limited to this; for example, information regarding the adjustment function that is executed in the image forming apparatus 100 may be obtained from the image forming apparatus 100, and the types and the like of patches to be attached to the reference image may be changeable or settable based on this obtained information. In this case, the information regarding the adjustment function needs to be consistent with such patterns as patches.

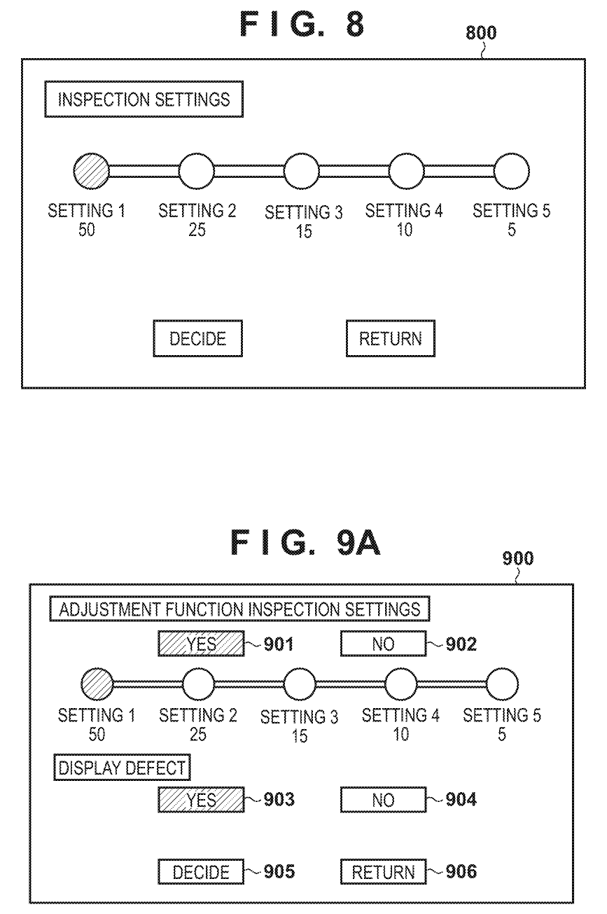

The operation and display unit 505 of the inspection apparatus 200 is a user interface on a touchscreen, and accepts a setting of an inspection level in the inspection processing in the inspection processing module 513 from a user. For example, the operation and display unit 505 displays a setting screen UI 800 shown in FIG. 8, and accepts a level setting of the inspection processing by the inspection processing module 513 from the user.

FIG. 8 is a diagram showing an example of a setting screen for an inspection level displayed on the operation and display unit 505 of the inspection apparatus 200 according to the first embodiment.

There are setting 1 to setting 5 as inspection levels that can be set by the user. The number shown below each of setting 1 to setting 5 indicates an inspection level (allowable error) corresponding to each setting. For example, if "setting 5" is selected now, the determination module 512 detects an image defect when a color difference (color distance), such as a stain and a scratch, determined in the inspection of the read image is equal to or larger than "5". On the other hand, if "setting 1" is selected as shown in FIG. 8, the determination module 512 detects an image defect when a color difference, such as a stain and a scratch, determined in the inspection of the read image is equal to or larger than "50". In this way, the larger the setting value of the inspection level is, the more the determination module 512 determines that an image defect is present, even if a color difference, such as a stain and a scratch, is minute. Therefore, the user can set an inspection level in the determination module 512 by selecting and pressing one of the setting buttons corresponding to "setting 1" to "setting 5".

Furthermore, as each setting value is applied to a color image, each setting value is associated with a color difference parameter in advance so that the larger the setting value, the smaller the color difference parameter, for example. Then, the operation and display unit 505 notifies the determination module 512 of the color difference parameter corresponding to the setting value selected by the user, and the determination module 512 detects a color shift and the like with use of the color difference parameter corresponding to the setting value.

Based on a setting value (allowable error) of an inspection level, the first embodiment determines whether a color difference of a stain or a scratch included in a read image, which is based on a difference between a read image and a reference image, is normal. However, the present disclosure is not limited to this, and whether the magnitude of the stain or the scratch is normal may be determined based on this setting value. For example, in the case of the magnitude, the inspection level (allowable error) may be settable in the range of 0.1 mm to 3 mm and the like.

Note that although image data used in printing is described as a reference image in the first embodiment, a method of generating a reference image is not limited to this. Similarly to a scan image, a reference image may be printed by the image forming apparatus 100, and an image read by the inspection sensor 403 may be used as a reference image. That is to say, image data obtained by reading an image of a printed material, on which a reference image including a patch image attached thereto is printed, with use of an inspection sensor may be held in the storage unit 504, and used at the time of collation. Furthermore, when no patch image is included in an image of a printed material that has been read at the time of generation of a reference image, it is permissible to attach a patch image to this read image and use the resultant patch image.

As described above, according to the first embodiment, an inspection on an entire image region can be executed even in the case of a printed material to which a patch image has been attached. Furthermore, if it has been determined that there is an image defect in a region of the patch image, adjusting processing related to this patch image is not executed; this brings about the effect of prevention of the execution of erroneous adjusting processing caused by, for example, reading of the patch image with the printing defect. <Second Embodiment>

The following describes image processing related to a second embodiment of the present disclosure.

The above first embodiment has been described using an example in which, as a patch image is attached to a reference image, an inspection is executed with respect to an entire image region of a printed material even in a case where the adjustment function is executed. In the first embodiment, as an entire image region of a printed material can be inspected, the adjustment function can be stabilized, and operations can be guaranteed for an entire surface of a print region. However, some users wish to accelerate processing and place priority on productivity by simplifying the adjustment function or omitting display of the inspection result. Therefore, in the second embodiment, a method of improving productivity will be discussed in view of the foregoing. Note that the system configuration, the hardware configurations of the image forming apparatus 100, the inspection apparatus 200, etc., and the like according to the second embodiment are similar to those of the first embodiment; therefore, a description of these is omitted, and the following describes only the differences from the first embodiment.

FIG. 9A is a diagram showing an example of a UI 900 of inspection settings for adjustment, which is displayed on the operation and display unit 505 of the inspection apparatus 200 according to the second embodiment.

The UI 900 is a setting screen on which an inspection level at the time of inspection is set similarly to the UI 800 of FIG. 8, and on which whether to configure the inspection settings for adjustment can be set. A "Yes" button 901 and a "No" button 902 of the inspection settings for adjustment are buttons for selecting whether to execute the inspection settings for adjustment. If the inspection settings for adjustment have been configured with the selection of the "Yes" button 901, an inspection level in an adjustment region can be set similarly to the UI 800. Also, if a process of determining whether to execute the inspection settings for adjustment is added before step S709 of FIG. 7, in a case where the "No" button 902 has been selected, it is determined that the inspection settings for adjustment have not been configured in this determination process, and processing proceeds to step S712. When step S709 to step S711 are skipped in this manner, the determination about whether there is an image defect in a patch region can be skipped in a case where the "No" button 902 has been selected.

Next, a "Yes" button 903 and a "No" button 904 for display of an image defect are buttons that enable selection of whether to display the detected image defect. In a case where the "Yes" button 903 has been selected, an inspection is executed and the image defect is displayed in step S712, similarly to the first embodiment. On the other hand, in a case where the "No" button 904 has been selected, even if an image defect is detected in a patch region in processing of step S712 of FIG. 7, the result of this detection is not displayed.

When a decide button 905 has been selected, the settings on this screen are finalized and saved in the storage unit 504. On the other hand, selecting a return button 906 cancels all of the settings on this screen and returns to a previous screen.

A description is now given of processing of step S712 in a case where it has been determined that there is an image defect in a patch region in step S709 of FIG. 7 in a state where the "No" button 904 for display of the image defect has been selected.

In step S712, the CPU 515 displays the inspection processing results on the operation and display unit 505, but does not display the image defect in the patch region at this time.

In the above-described manner, processing can be accelerated by simplifying the adjustment function and omitting display of the inspection result for a user who places priority on productivity.

Also, according to another aspect, the occurrence of an image defect can be detected also on paper of a specific size. Specifically, for example, depending on the paper size, an attached patch region can be a print region in another job that performs printing on paper of another size. For this reason, the states of the patch region may be stored for the respective paper sizes. In this way, for example, in a job that prints an A5-sized flyer, both of the inspection function and the adjustment function are executed. Thereafter, a job that prints an A3-sized poster is executed. At this time, in printing of the A3-sized poster, both of the inspection function and the adjustment function are executed. In this case, the entirety of the region of the A5 size is included in the region of the A3-sized poster; therefore, even when an image defect has occurred in a region in which the inspection has been determined to be unnecessary in the A5 size, this region is an inspection target region in the A3-sized poster, and thus the image defect that has occurred in this region can be detected. <Modification Example of Second Embodiment>

The following describes image processing related to a modification example of the second embodiment of the present disclosure.

The second embodiment has been described using an example in which the adjustment function can be stabilized also for a user who places priority on productivity. There are cases where it is desirable to configure further settings as a method of improving productivity. For example, there may be cases where it is desirable to perform a strict inspection on tint patches, and perform a simple inspection on front and back registration markers. In view of this, the present modification example will be described in relation to another method that improves convenience while improving productivity.

Note that the following describes only the differences from the second embodiment.

FIG. 9B is a diagram showing an example of a UI 910 of inspection settings for adjustment, which is displayed on the operation and display unit 505 of the inspection apparatus 200 according to the modification example of the second embodiment.

Similarly to the UI 900, this UI 910 shows inspection settings related to the adjustment function. The difference from the UI 900 is provision of setting items for each patch type. Hereinafter, the present modification example will be described in relation to a method that configures settings for tint adjustment patches and front and back registration markers independently.

A "Yes" button 911 and a "No" button 912 for inspection settings are buttons for selecting whether to execute an adjustment function inspection on the tint adjustment patches. Also, a "Yes" button 913 and a "No" button 914 for display of an image defect are buttons for selecting whether to display an image defect detected using the tint adjustment patches.

Meanwhile, a "Yes" button 915 and a "No" button 916 for inspection settings for the front and back registration markers are buttons for selecting whether to execute an adjustment function inspection with use of the front and back registration markers. Also, a "Yes" button 917 and a "No" button 918 for display of an image defect are buttons for selecting whether to display an image defect detected using the front and back registration markers.

Furthermore, a decide button 919 and a return button 920 have functions similar to those of the decide button 905 and the return button 906 of FIG. 9A.

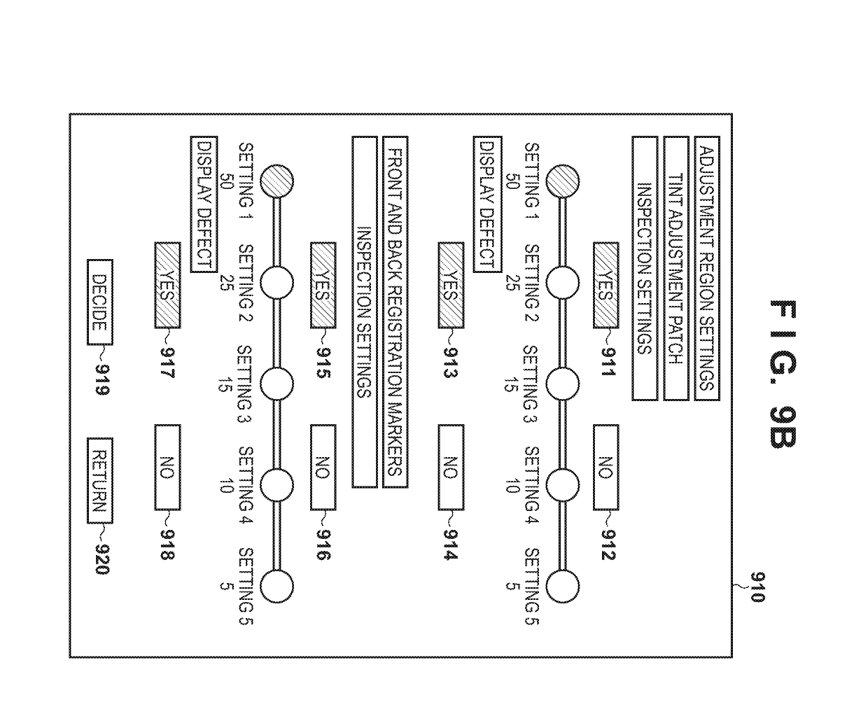

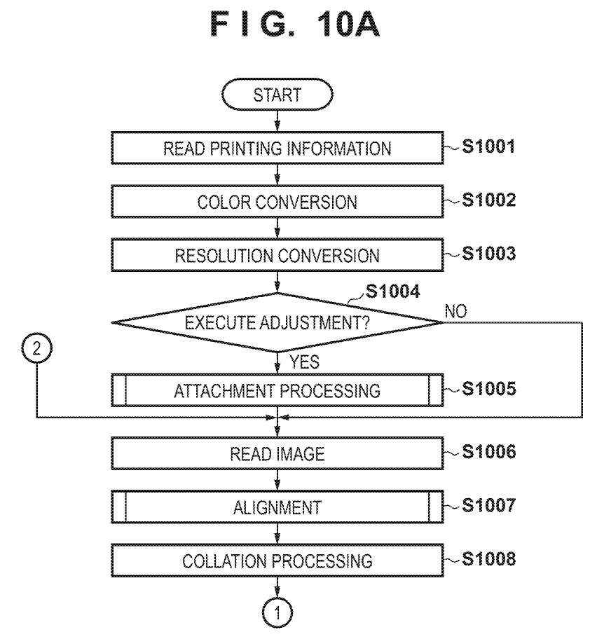

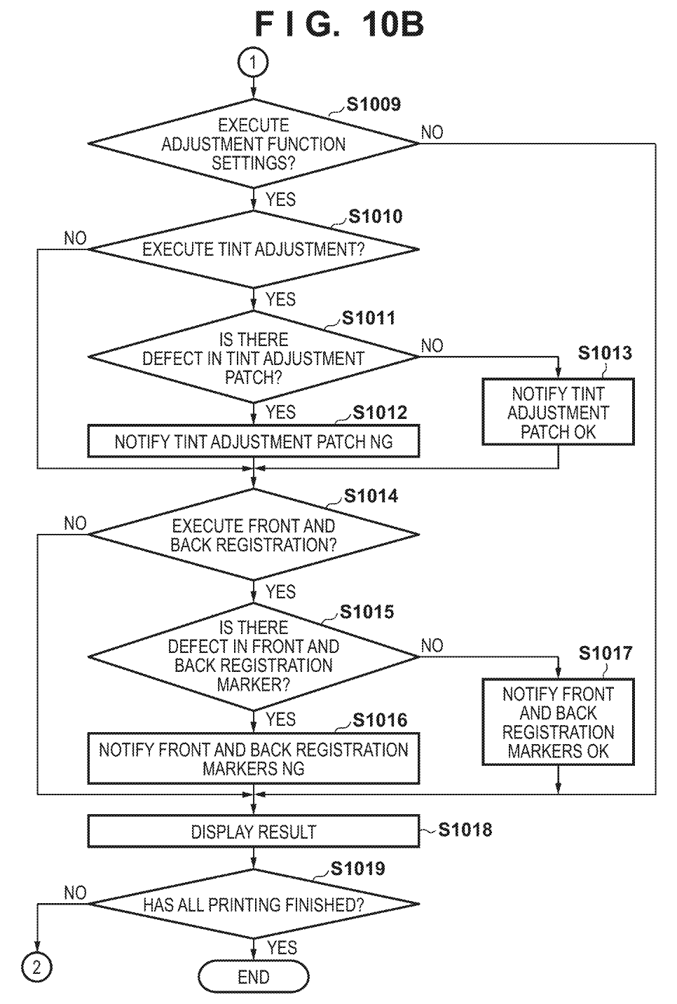

FIGS. 10A and 10B are flowcharts for describing the inspection processing by the inspection apparatus 200 according to the modification example of the second embodiment. Note that processing described by this flowchart is realized by the CPU 515 of the control unit 503 executing a program deployed from the storage unit 504 to the memory 516. Note that in FIGS. 10A and 10B, processing of step S1001 to step S1008 is the same as that of steps S701 to S708 of FIG. 7, and processing of step S1019 is the same as that of step S713 of FIG. 7; therefore, a description of these is omitted.

In step S1009, the CPU 515 determines whether the inspection settings for adjustment have been set to be executed with the selection of the "Yes" button 901 for executing the inspection settings for adjustment on the UI 900 of the inspection settings for adjustment of FIG. 9A. If the inspection settings for adjustment have been set to be executed, processing proceeds to step S1010; otherwise, processing proceeds to step S1018.

In step S1010, the CPU 515 determines whether the tint adjustment has been set to be executed with the selection of the "Yes" button 911 for executing the tint adjustment on the UI 910 of the inspection settings for adjustment of FIG. 9B. If the tint adjustment has been set to be executed, processing proceeds to step S1011; otherwise, processing proceeds to step S1014. In step S1011, the CPU 515 determines whether there has been an image defect in a tint adjustment patch region. The tint adjustment patch region is indicated by coordinate information obtained by compositing a tint adjustment patch image in the attachment processing of step S1005, and this coordinate information is obtained from the storage unit 504. In a case where it has been determined that there is an image defect in the tint adjustment patch region, processing proceeds to step S1012. On the other hand, in a case where it has been determined that there is no image defect in the tint adjustment patch region, processing proceeds to step S1013.

In step S1012, the CPU 515 notifies the adjusting apparatus 400 of the presence of the image defect inside the tint adjustment patch region via the communication unit 502, and processing proceeds to step S1014. Upon receiving this notification, the adjusting apparatus 400 provides the image forming apparatus 100 with a notification indicating that the result obtained from the tint adjustment patches is not to be reflected in the tint adjusting processing.

Meanwhile, in step S1013, in contrast with step S1012, the CPU 515 notifies the adjusting apparatus 400 of the absence of the image defect inside the tint adjustment patch region via the communication unit 502, and processing proceeds to step S1014. Upon receiving this notification, the adjusting apparatus 400 notifies the image forming apparatus 100 of the result obtained from the tint adjustment patches.

In step S1014, the CPU 515 determines whether the front and back registration adjustment has been set to be executed with the selection of the "Yes" button 915 for executing the front and back registration adjustment on the UI 910 of the inspection settings for adjustment of FIG. 9B. If the front and back registration adjustment has been set to be executed, processing proceeds to step S1015; otherwise, processing proceeds to step S1018. In step S1015, the CPU 515 determines whether there has been an image defect in a front and back registration marker region. The front and back registration marker region is distinguished by obtaining coordinate information from the storage unit 504, similarly to step S1011. The processing contents of step S1016 and step S1017 are the same as those of step S1012 and step S1013 described above, except that the tint adjustment patch region is replaced with the front and back registration marker region; therefore, a description thereof is omitted. Then, processing proceeds to step S1018, and the CPU 515 displays the inspection result similarly to step S712. In display of the inspection result, the inspection result is displayed in accordance with the collation result in step S1008, the determination results in step S1011 and step S1015, and settings on the setting screen of the above-described UI 910.

As described above, according to the second embodiment, the adjustment function can be stabilized and convenience can be improved by making the adjustment function selectable, or by simplifying the adjustment function, also for a user who places priority on productivity.

Also, as different inspection levels can be set for a tint adjustment patch region and a front and back registration marker region, the inspection levels for such regions as a patch region and a marker region can be made lower than the inspection level for an image region. This is because the inspection performed on the patch region need not be as strict as the inspection performed on a printed image.

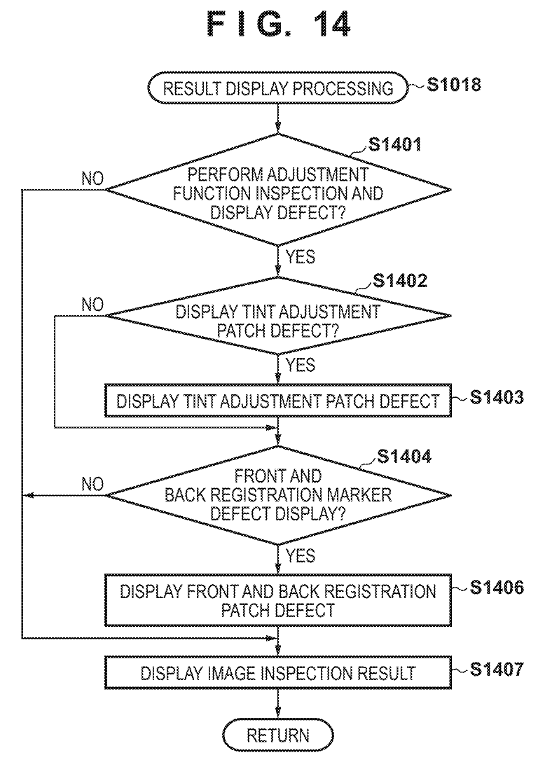

FIG. 14 is a flowchart for describing result display processing of step S1018 according to the modification example of the second embodiment.

First, in step S1401, the CPU 515 determines whether the adjustment function inspection has been set to be performed with the selection of the "Yes" button 901, and an image defect has been set to be displayed with the selection of the "Yes" button 903 for display of the image defect, on the screen of FIG. 9A. Here, if it has been determined that the adjustment function inspection has not been set to be executed, or the image defect has not been set to be displayed with the selection of the "No" button 904 for display of the image defect, processing proceeds to step S1407. On the other hand, if the adjustment function inspection has been set to be executed and the image defect has been set to be displayed with the selection of the "Yes" button 903 for display of the image defect, processing proceeds to step S1402. In step S1402, the CPU 515 determines whether the "Yes" button 913 for displaying the image defect detected in the tint adjustment patches has been selected on the screen of FIG. 9B. If the "Yes" button 913 has been selected, processing proceeds to step S1403, the image defect detected in the tint adjustment patches is displayed, and processing proceeds to step S1404. On the other hand, if the "No" button 914 has been selected, processing proceeds to step S1404.

In step S1404, the CPU 515 determines whether the "Yes" button 917 for displaying the image defect in front and back registration patches has been selected on the screen of FIG. 9B. If the "Yes" button 917 has been selected, processing proceeds to step S1406, the image defect detected in the front and back registration markers is displayed, and processing proceeds to step S1407. On the other hand, if the "No" button 918 has been selected, processing proceeds to step S1407. In step S1407, the CPU 515 controls whether to add the display contents of step S1403 and step S1406 in accordance with whether display of the image defect detected in the tint adjustment patches has been selected, and with whether display of the image defect detected in the front and back registration markers has been selected, and displays an inspection result that is based on collation between the read image and the reference image in step S1008; then, the present processing is ended. (Other Embodiments)

Embodiments of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer-executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD) ^{TM}), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims priority to Japanese Patent Application No. 2025-001912, which was filed on January 6, 2025 and which is hereby incorporated by reference herein in its entirety.

What is claimed is:

1. An image forming system comprising an image forming apparatus and an inspection apparatus,
the image forming apparatus having one or more first controllers including one or more first processors and one or more first memories, wherein the one or more first controllers configured to:
form, on a recording medium, an image to which a predetermined image is attached to create a printed material; and
provide the inspection apparatus with information regarding the predetermined image, and
the inspection apparatus having one or more second controllers including one or more second processors and one or more second memories, wherein the one or more second controllers configured to:
obtain a read image by reading the printed material created by the image forming apparatus;
inspect an image of the printed material by collating the read image and a reference image; and
based on the information, attach the predetermined image to the reference image before the inspection on the image of the printed material.

2. The image forming system according to claim 1, wherein
the information regarding the predetermined image includes a type of the predetermined image, and position information indicating a position of the predetermined image in the printed material.

3. The image forming system according to claim 1, wherein
the predetermined image includes at least one of a first patch image for adjusting a position of an image to be formed by the image forming apparatus, and a second patch image for adjusting a tint of the image to be formed by the image forming apparatus.

4. The image forming system according to claim 1, wherein
the one or more second controllers are further configured to perform control to, in a case where an image defect is detected in the predetermined image in the inspection of the image of the printed material, not execute adjusting processing for the image forming apparatus related to the predetermined image.

5. The image forming system according to claim 1, wherein
the one or more second controllers are further configured to set an allowable error used in an inspection determination in the inspection of the image of the printed material, and
in the inspection of the image of the printed material, the one or more second controllers determine that the read image includes an image defect in a case where a difference obtained by the collation between the read image and the reference image is larger than the allowable error.

6. The image forming system according to claim 3, wherein
the one or more second controllers are further configured to allow a user to select whether to execute adjustment of the position of the image.

7. The image forming system according to claim 3, wherein
the one or more second controllers are further configured to allow a user to select whether to execute adjustment of the tint of the image.

8. The image forming system according to claim 3, wherein
the one or more second controllers are further configured to allow a user to select whether to display an inspection result for at least one of the first patch image and the second patch image, the inspection result being obtained in the inspection of the image of the printed material.

9. An inspection apparatus that inspects a printed material formed by an image forming apparatus, the inspection apparatus comprising
one or more controllers including one or more processors and one or more memories, wherein the one or more controllers are configured to:
obtain a read image by reading a printed material formed by the image forming apparatus;
inspect an image of the printed material by collating the read image and a reference image; and
attach, based on information regarding a predetermined image attached to the printed material, the predetermined image to the reference image before the inspection of the image of the printed material.

10. The inspection apparatus according to claim 9, wherein
the information regarding the predetermined image is obtained from the image forming apparatus.

11. The inspection apparatus according to claim 9, wherein
the information regarding the predetermined image includes a type of the predetermined image, and position information indicating a position of the predetermined image in the printed material.

12. The inspection apparatus according to claim 9, wherein
the predetermined image includes at least one of a first patch image for adjusting a position of an image to be formed by the image forming apparatus, and a second patch image for adjusting a tint of the image to be formed by the image forming apparatus.

13. The inspection apparatus according to claim 9, wherein
the one or more controllers are further configured to perform control to, in a case where a defect section is detected in the predetermined image in the inspection of the image of the printed material, not execute adjusting processing for the image forming apparatus related to the predetermined image.

14. The inspection apparatus according to claim 9, wherein
the one or more controllers are further configured to set an allowable error used in determination in the inspection of the image of the printed material, and
in the inspection of the image of the printed material, the one or more controllers determine that the read image includes a defect section in a case where a difference obtained by the collation between the read image and the reference image is larger than the allowable error.

15. The inspection apparatus according to claim 12, wherein
the one or more controllers are further configured to allow a user to select whether to execute adjustment of the position of the image.

16. The inspection apparatus according to claim 12, wherein
the one or more controllers are further configured to allow a user to select whether to execute adjustment of the tint of the image.

17. The inspection apparatus according to claim 12, wherein
the one or more controllers are further configured to allow a user to select whether to display an inspection result for at least one of the first patch image and the second patch image, the inspection result being obtained in the inspection of the image of the printed material.
